(19) United States
(12) Patent Application Publication
(10) Pub. No.: US 2006/0073465 A1
(43) Pub. Date: Apr. 6, 2006

(54) Answer sheet adapted for computer scoring

(76) Inventor: Hideyuki Kubo, Tokyo (JP)

Correspondence Address: JUNICHI MIMURA;OKI AMERICA INC., 1101 14TH STREET, N.W., SUITE 555, WASHINGTON, DC, 20005, US

(21) Appl. No.: 10/936,671

(22) Filed: Sep. 9, 2004

(51) Int. Cl. G09B 3/00

(52) U.S. Cl. 434/353

(57) ABSTRACT

An answer sheet adapted for computer scoring has a first mark enclosing a space, printed on the sheet, and a second mark enclosing a space, printed on the sheet, wherein the second mark is encompassed by the first mark.

### BACKGROUND OF THE INVENTION

1. Field of the Invention

This invention relates to an answer sheet adapted for computer scoring, specifically to an answer sheet having marks to be filled with a pencil or pen in order to be recognized by computer.

2. Description of the Related Art

Answer sheet adapted for computer scoring are used for many kinds of questionnaires and examinations. A conventional answer sheet of this type for a multiple-choice exam is illustrated in FIG. 1. The answer sheet 1 is marked with ellipses 2. If there are four choices for the first question, there are four ellipses 2A-2D. When a test taker chooses an answer A to the first question, he should fill the first ellipse 2A in a row A completely, then go to the next question. At the time of scoring, a computer scans the answer sheet. In order to be recognized by computer, the ellipses 2 should be filled completely. Otherwise, the computer may not recognize the selection marked by the test taker. Thus, normally before an examination is started, instructions are given to the test taker to fill the ellipses accurately. The instruction typically includes a good and bad examples as shown respectively in FIGS. 2A and 2B.

In most cases of the bad example shown in FIG. 2B, although it is noticed that the computer does not recognize the selection, like Questions 1-3, the computer sometimes recognizes the test taker's selection in some bad examples wherein ink runs slightly off the edge of the ellipse, like Question 2. However, the test taker may think that the part, which runs off the edge of the ellipse, should be erased. Sometimes, the test taker may erase all of the filled part, and refill the ellipse to avoid potential computer scoring problem. Such efforts are time-consuming and may seriously effect to the test taker's score when the test time is very limited. For example, an examination that is a test for qualifications to enter a professional field, such as a bar examination or a medical doctor examination, the test influence the fate of the test taker.

Thus, it is widely requested to improve the answer sheet, by providing one that does not require the ellipse to be filled in with great precision and accuracy, in order to allow the test taker focus on spending more time for answering the questions, not filling the ellipses precisely and accurately.

### SUMMARY OF THE INVENTION

An objective of the invention is to provide an answer sheet adapted for computer scoring that a test taker easily can mark the selected answers quick and accurately.

To achieve this objective, an answer sheet of the invention has a first mark printed on the sheet and a second mark printed on the sheet wherein the second mark is encompassed by the first mark.

### BRIEF DESCRIPTION OF THE DRAWINGS

The invention will be more particularly described with reference to the accompanying drawings in which:

FIG. 1 shows a conventional answer sheet adapted for computer scoring;

FIG. 2A shows a good example when a test taker selects an answer in the conventional answer sheet;

FIG. 2B shows a bad example when a test taker selects an answer in the conventional answer sheet;

FIG. 3 shows an answer sheet adapted for computer scoring of the first embodiment of the invention;

FIG. 4 shows a correctly filled sample answer using the answer sheet of the first embodiment;

FIG. 5A shows first alternative answer sheet of the invention;

FIG. 5B shows second alternative answer sheet of the invention; and

FIG. 5C shows third alternative answer sheet of the invention.

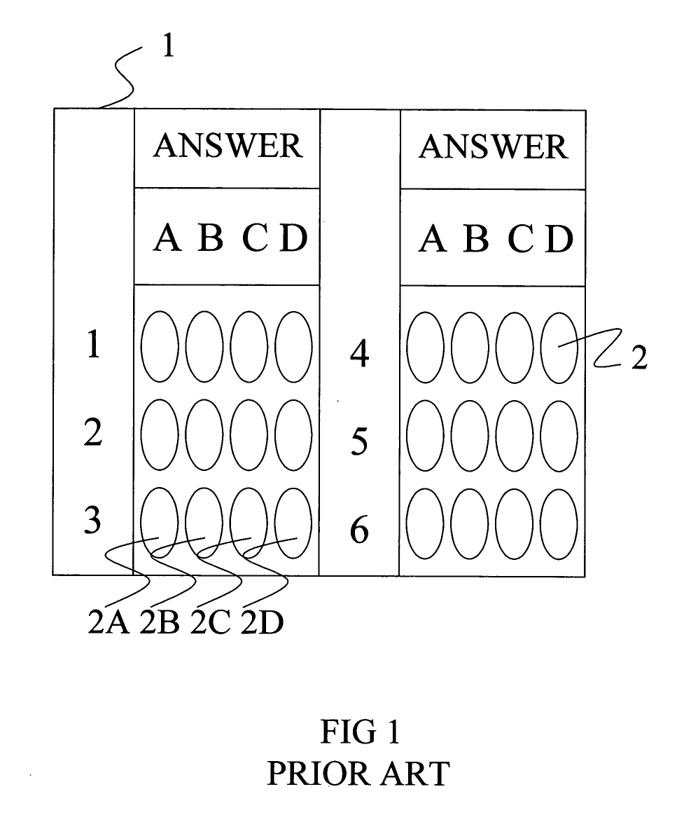

### BRIEF DESCRIPTION OF THE PREFERRED EMBODIMENTS

In each drawing, the same reference numbers designate the same or similar components.

### First Embodiment

FIG. 3 shows an answer sheet adapted for computer scoring. The answer sheet 100 includes a lot of marks 101. The marks 101 are printed on the answer sheet 100. In the first embodiment, each mark 101 is drawn as an ellipse. Each of marks 101 consists of a first mark (in the first embodiment, a first ellipse) 101A and a second mark (in the first embodiment, a second ellipse) 101B, which is completely encompassed by the first mark 101A. The first and second marks 101A and 101B have the same center of gravity. In the first embodiment, since the first and second marks are drawn as ellipses, these ellipses are drawn as concentric shapes. The first and second ellipses 101A and 101B are drawn with the same color.

As shown in FIG. 3, the marks 101 are aligned in a reticular pattern. The first row of the marks 101 is for the first multiple-choice question. In the first embodiment, there are four choices for the first question so that the four marks 101 are drawn in the first row. If a test taker selects the first of the four choices, then he selects the leftmost mark.

When the answer sheet 100 is used for the test, a test taker is instructed as follows:

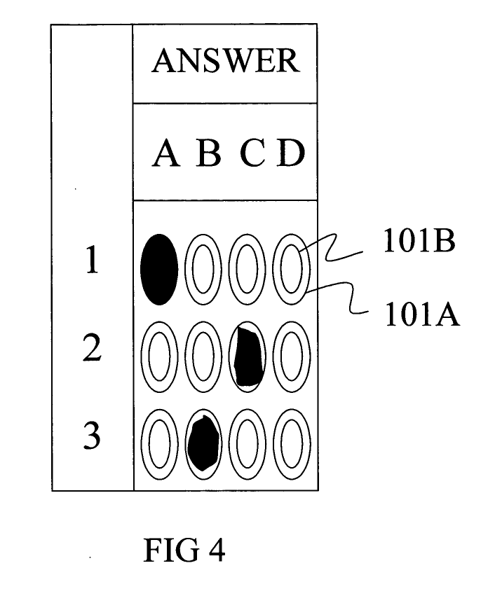

Fill in the second ellipse 101B of your selected mark 101 completely. If the ink does not run off the first ellipse 101A, then your selected mark can be recognized by the computer as being selected by the test taker. See the good example (FIG. 4).

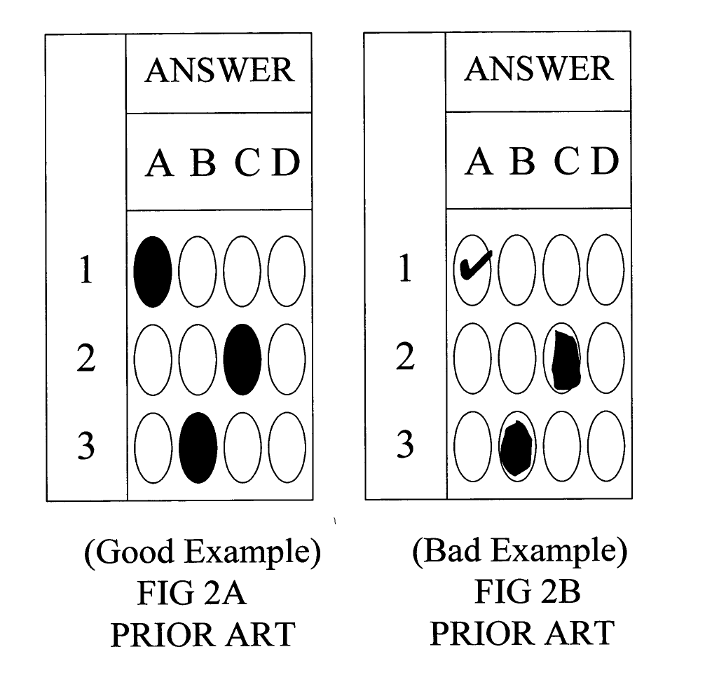

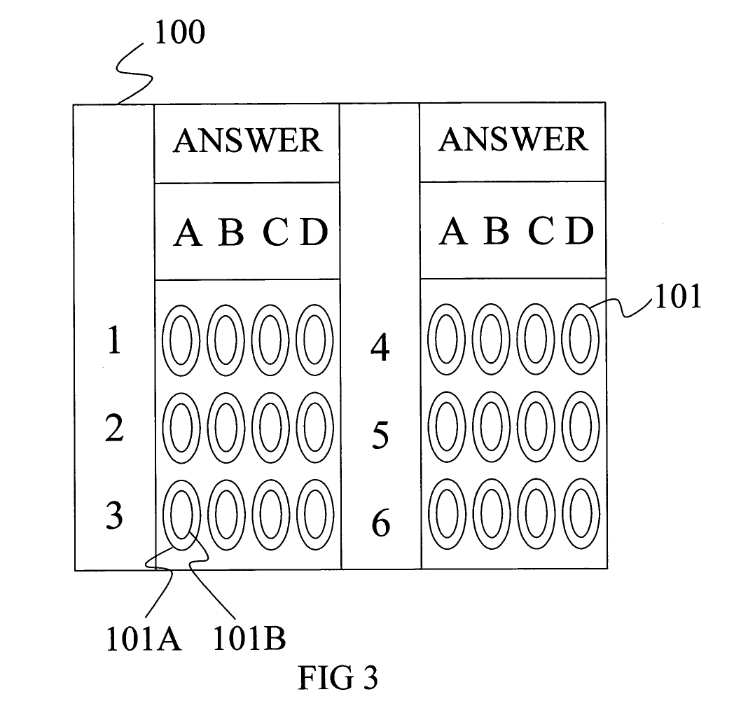

Comparing to the bad example shown in FIG. 2B, in the case when the same fillings are used in FIG. 4, while the computer may not recognize the answers to the Questions 2 and 3 in FIG. 2B, the computer recognize the answers of the Questions 2 and 3 in FIG. 4. This is because the computer, having an optical scanner, recognizes which ellipses the test taker marked when at least the second ellipse is filled completely. Thus, it is not necessary to border the mark 101 to fill completely as shown in the mark at the row 1, and the column A in FIG. 4 so that the test taker can move the pencil quickly to select the answer. The time consumed to fill the mark 101 can be dramatically reduced, and it is easily possible to confirm whether or not filling the mark is made accurately.

According to the first embodiment, the requirement for filling the mark 101 is less restrictive, and the test talker would be released from the mental stress, and would fill the mark quickly so that he can concentrate to answer the question.

### The Second Embodiments

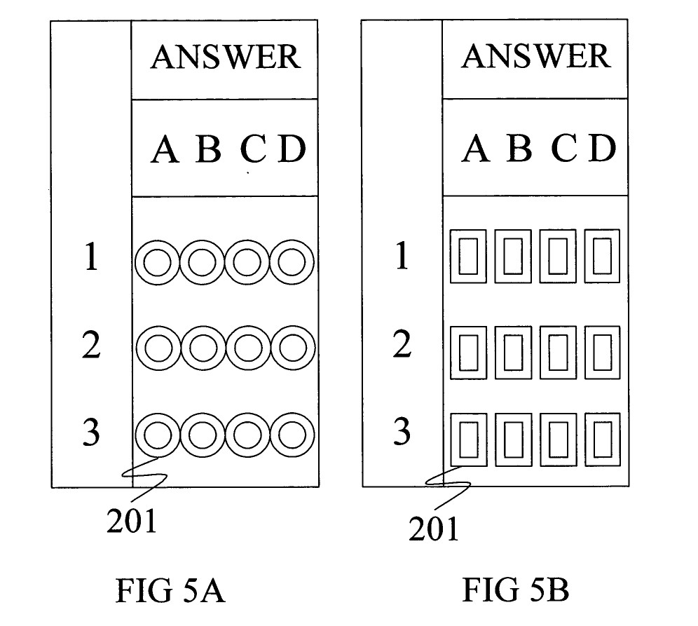

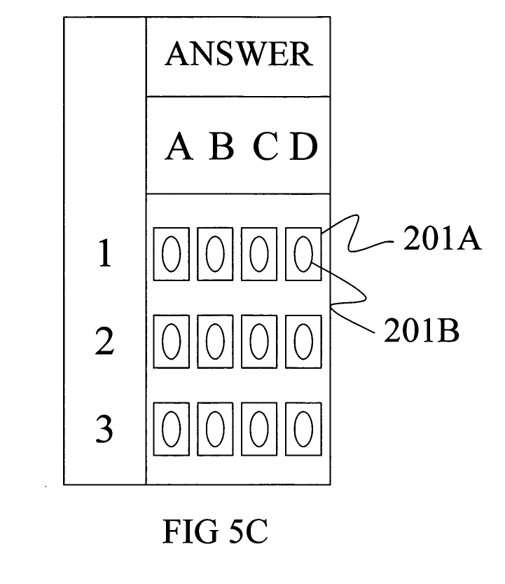

In the first embodiment, the mark 101 is drawn as an ellipse. In the second embodiments, the mark 201 is drawn as a circle as shown in FIG. 5A or as a rectangle shown in FIG. 5B. Alternatively, as shown in FIG. 5C, it is possible to use the second mark 201B which has a different shape than the first mark 201A if the first mark 201A encompasses the second mark completely. Preferably, the center of the gravity of the first and second marks is the same. In FIG. 5C, the first mark 201A is drawn as a rectangular, and the second mark 201B is drawn as an ellipse.

Further, in the first embodiment, the first and second ellipses 101A and 101B are drawn with the same color. In the second embodiment, the different colors can be used between the first mark and the second mark. For easy confirmation by the test taker whether or not he filled the mark correctly, it is preferable to use the second mark having color, which is different from the color of the test taker's pencil. If the color of the second mark is different from that of the pencil, the test taker can easily recognize the second mark is not filled completely.

While the present invention has been described with reference to illustrative embodiments, this description is not intended to be construed in a limiting sense. Various modifications of the illustrated embodiments, as well as other embodiments of the invention, will be apparent to those skilled in the art on reference to this description. Therefore, the appended claims are intended cover any such modifications or embodiments as falls within the true scope of the invention.

What is claimed is:

1. An answer sheet adapted for computer scoring, comprising:
a first mark enclosing a space, printed on the sheet; and
a second mark enclosing a space, printed on the sheet, wherein the second mark is encompassed by the first mark.

2. An answer sheet adapted for computer scoring as claimed in claim 1, wherein the first and second marks have the same center of gravity.

3. An answer sheet adapted for computer scoring as claimed in claim 1, wherein the first and second marks are the same shapes and wherein the second mark is smaller than the first mark.

4. An answer sheet adapted for computer scoring as claimed in claim 2, wherein the first and second marks are the same shapes and wherein the second mark is smaller than the first mark.

5. An answer sheet adapted for computer scoring as claimed in claim 3, wherein the first and the second marks are circles.

6. An answer sheet adapted for computer scoring as claimed in claim 4, wherein the first and the second marks are circles.

7. An answer sheet adapted for computer scoring as claimed in claim 3, wherein the first and the second marks are ellipses.

8. An answer sheet adapted for computer scoring as claimed in claim 4, wherein the first and the second marks are ellipses.

9. An answer sheet adapted for computer scoring as claimed in claim 3, wherein the first and the second marks are rectangles.

10. An answer sheet adapted for computer scoring as claimed in claim 4, wherein the first and the second marks are rectangles.

11. An answer sheet adapted for computer scoring as claimed in claim 1, wherein color of the second mark is difference from that of the first mark.

12. An answer sheet adapted for computer scoring as claimed in claim 1, wherein color of the second mark is different from that of an ink which is used to fill the second mark.

13. An answer sheet adapted for computer scoring as claimed in claim 1, wherein color of the first and second marks is the same.

14. An answer sheet adapted for computer scoring as claimed in claim 1, wherein the first and second marks are different shapes and wherein the second mark is smaller than the first mark.

15. An answer sheet adapted for computer scoring as claimed in claim 14, wherein the first and the second marks are circles.

16. An answer sheet adapted for computer scoring as claimed in claim 14, wherein the first and the second marks are ellipses.

17. An answer sheet adapted for computer scoring as claimed in claim 14, wherein the first and the second marks are rectangles.

18. An answer sheet adapted for computer scoring as claimed in claim 2, wherein the first and second marks are different shapes and wherein the second mark is smaller than the first mark.

19. An answer sheet adapted for computer scoring as claimed in claim 18, wherein the first and the second marks are circles.

20. An answer sheet adapted for computer scoring as claimed in claim 18, wherein the first and the second marks are ellipses.

21. An answer sheet adapted for computer scoring as claimed in claim 18, wherein the first and the second marks are rectangles.
